(19) United States
(12) Patent Application Publication
(10) Pub. No.: US 2024/0173941 A1
(43) Pub. Date: May 30, 2024

(54) Gypsum Panel with Enhanced Fire Resistance

(71) Applicant: Gold Bond Building Products, LLC, Charlotte, NC (US)

(72) Inventors: Eli Stav, Charlotte, NC (US); R. G. Iyer, Charlotte, NC (US); Bradley J. Busche, Shelby, NC (US); Joseph J. Bailey, Charlotte, NC (US); Brian Bland, Matthews, NC (US); Veda Evans, Charlotte, NC (US)

(21) Appl. No.: 18/507,190

(22) Filed: Nov. 13, 2023

Related U.S. Application Data
(60) Provisional application No. 63/425,069, filed on Nov. 14, 2022.

(51) Int. Cl. B32B 13/02; B32B 7/02; B32B 13/04; B32B 37/15; C04B 14/06; C04B 14/16; C04B 24/42; C04B 28/14; E04C 2/04

(52) U.S. Cl. CPC B32B 13/02; B32B 7/02; B32B 13/04; B32B 37/15; C04B 14/062; C04B 14/16; C04B 24/42; C04B 28/14; E04C 2/043; B32B 2250/40; B32B 2264/0214; B32B 2264/1021; B32B 2264/303; B32B 2307/304; B32B 2307/3065; B32B 2307/308; B32B 2307/718; B32B 2307/72; B32B 2318/00; B32B 2607/00; C04B 2111/0062

(57) ABSTRACT

The present invention is directed to a gypsum panel and a method of making such gypsum panel. For instance, in one embodiment, the gypsum panel comprises a gypsum core and a first facing material and a second facing material sandwiching the gypsum core, wherein the gypsum core includes gypsum and one or more fire resistance additives. The methods of the present invention are directed to making the aforementioned gypsum panels by providing the first facing material, providing a gypsum slurry comprising gypsum, water, and one or more fire resistance additives onto the first facing material, and providing a second facing material on the gypsum slurry.

### RELATED APPLICATIONS

The present application is based on and claims priority to U.S. Provisional Patent Application Ser. No. 63/425,069, having a filing date of Nov. 14, 2022, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum, water, and other conventional additives. The mixture is cast and allowed to set by reaction of the calcined gypsum with the water. During the production process, a variety of additives can be incorporated into the gypsum panel to enhance the physical and mechanical properties of the gypsum panel.

In recent years, various additives have been utilized in gypsum panels to enhance the fire resistance properties of gypsum panels. However, the type of fire resistance additives utilized and the location of the fire resistance additives in the gypsum panel are exceptionally wide-ranging. As such, it remains to be ascertained which type of fire resistance additives and which locations of the fire resistance additives are most suitable for use in a gypsum panel.

As a result, a need exists for providing a gypsum panel with improved fire resistance properties. In particular, a need exists for providing a gypsum panel with reduced shrinkage and enhanced insulative properties when exposed to high temperatures.

### SUMMARY OF THE INVENTION

In accordance with one embodiment of the present invention, a gypsum panel is disclosed. The gypsum panel comprises a gypsum core and a first facing material and a second facing material sandwiching the gypsum core, the gypsum core comprising gypsum and one or more fire resistance additives comprising a shrinkage control composition, a thermal insulation composition, or a combination thereof, the gypsum core comprising a first gypsum core layer, a second gypsum core layer, and a third gypsum core layer, wherein the first gypsum core layer comprises the shrinkage control composition, wherein the third gypsum core layer comprises the thermal insulation composition.

In accordance with another embodiment of the present invention, a method of making a gypsum panel is disclosed. The method comprises: providing a first facing material; depositing a first gypsum slurry comprising stucco, water and a shrinkage control composition onto the first facing material, wherein the first gypsum slurry forms the first gypsum core layer; depositing a second gypsum slurry comprising stucco and water onto the first gypsum slurry, wherein the second gypsum slurry forms the second gypsum core layer; depositing a third gypsum slurry comprising stucco, water and a thermal insulation composition onto the second gypsum slurry, wherein the third gypsum slurry forms the third gypsum core layer; providing the second facing material on the third gypsum slurry; and allowing the stucco to convert to calcium sulfate dihydrate.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core including one or more fire resistance additives as defined herein. In this regard, the gypsum core can include gypsum (i.e., calcium sulfate dihydrate), one or more fire resistance additives, and may include other optional additives. The present inventors have discovered that the gypsum panel disclosed herein can have various benefits due to the use of one or more fire resistance additives. For instance, the present inventors have discovered that the mechanical properties and characteristics of the panel may be improved. For instance, the gypsum panel disclosed herein may have decreased shrinkage and increased thermal insulative properties when compared to traditional fire resistant gypsum panels.

It should be understood that throughout the entirety of this specification, each numerical value (e.g., weight percentage, concentration) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

In general, the fire resistance of a gypsum panel is derived from the loss of crystalline water present in the gypsum molecular structure. Gypsum contains two moles of crystalline water in its molecular structure, or approximately 21% water by weight. When exposed to high temperatures, gypsum goes through two principal dehydration reactions. In the first reaction, gypsum undergoes a dehydration reaction to form calcium sulfate hemihydrate.

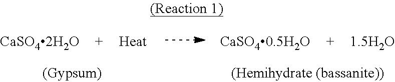

In the second reaction, the calcium sulfate hemihydrate is further dehydrated and converted to the soluble form of calcium sulfate anhydrite.

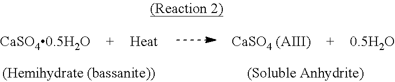

In the second reaction, less soluble phases of anhydrite may be generated. For instance, anhydrite(I) (i.e., AI), anhydrite(II) (i.e., AII), or a combination thereof may be generated by the second reaction. In this respect, factors such as higher temperatures, longer residence time, higher pressures, and a decrease in the particle size of the stucco may increase insoluble anhydrite(II) formation in the second reaction.

The dehydration reactions are endothermic reactions that absorb energy from the surroundings, usually in the form of heat. The endothermic reactions hold the gypsum panel at a constant temperature until fully dehydrated or until phase transition is complete, which slows the temperature rise on the unexposed facing material of the gypsum panel during exposure of the gypsum panel to a fire or heat. The release of water in these dehydration reactions may further delay the progress of fire or heat.

However, the dehydration of the gypsum panel may result in the formation of cracks in the gypsum panel, shrinkage of the gypsum panel, fall-off of the gypsum panel, increased thermal transmission through the gypsum panel, and/or ignition of the building components behind the gypsum panel, such as wood. The present inventors have discovered that the gypsum panel disclosed herein can delay, mitigate, reduce, or prevent: the formation of cracks in the gypsum panel, the shrinkage of the gypsum panel, fall-off of the gypsum panel, thermal transmission through the gypsum panel, and/or the ignition of the building components behind the gypsum panel.

In general, the gypsum core may comprise calcium sulfate dihydrate. The gypsum may be from a natural source or a synthetic source and is thus not necessarily limited by the present invention. In addition, the gypsum may be from a virgin source or a reclaim source. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In one aspect, the gypsum core may include a first gypsum core layer and a second gypsum core layer. The first gypsum core layer may be between a first facing material (e.g., front of the panel) and the second gypsum core layer. The first gypsum core layer may be adjacent to the first facing material. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one aspect, a gypsum slurry containing the foam and/or a foaming agent can be aggressively vibrated to induce air void separation to result in the formation of two or more gypsum core layers, where air bubbles will rise and coalesce to a top layer of the gypsum core (e.g., second gypsum core layer, third gypsum core layer) leaving a dense layer (e.g., first gypsum core layer) positioned relative to the first facing material. In some embodiments, such dense layer of the core layer may be adjacent to the facing material at the front of the gypsum panel. In some embodiments, such dense layer may have a higher density than the other gypsum core layer(s).

In one embodiment, the gypsum core may include a third gypsum core layer. The third gypsum core layer may be between the second gypsum core layer and a second facing material (e.g., back of the panel). The third gypsum core layer may be adjacent to the second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core layers. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or more foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. Further, a second facing material may be provided on the third gypsum slurry. The first gypsum slurry, second gypsum slurry, and/or third gypsum slurry may include one or more fire resistance additives. For instance, the first gypsum slurry, second gypsum slurry, and/or third gypsum slurry may include a shrinkage control composition, a thermal insulation composition, or a combination thereof. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

It should be noted that in one aspect, the first gypsum core layer, the second gypsum core layer, the third gypsum core layer, or a combination thereof may have the same density. Further, it should be noted that, in another aspect, the first gypsum core layer and/or the third gypsum core layer may have a density less than that of the second gypsum core layer.

Generally, one or more fire resistance additives may be present in any element of the disclosed gypsum panel. For instance, one or more fire resistance additives may be present in one or more of the facing materials of the gypsum panel. Additionally or alternatively, for instance, one or more fire resistance additives may be present in the gypsum slurry or the gypsum core of the gypsum panel. In this respect, for instance, one or more fire resistance additives may be present in one or more gypsum core layers (e.g., first gypsum core layer, second gypsum core layer, third gypsum core layer) of the gypsum panel.

Various gypsum core layers may be a particularly suitable location for one or more fire resistance additives. For instance, in one aspect, having a fire resistance additive present in the first gypsum core layer and/or third gypsum core layer may have enhanced efficacy in reducing or preventing the formation of cracks, the shrinkage of the gypsum panel, fall-off of the gypsum panel, thermal transmission through the gypsum panel, and/or the ignition of the building components behind the gypsum panel when compared to a gypsum panel having a similar amount of a fire resistance additive present in the second gypsum core layer. Such enhanced efficacy may be at least partially a result of the concentration of the fire resistance additive present in the first gypsum core layer and/or third gypsum core layer, which may be more than the concentration of the fire resistance additive present in the second gypsum core layer. In this respect, adding an amount of a fire resistance additive in the first gypsum core layer and/or third gypsum core layer may be more effective than adding the same amount of a fire resistance additive in the second gypsum core layer.

As previously disclosed, the gypsum core of the present disclosure may contain one or more fire resistance additives. Notably, the gypsum core may include one or more fire resistance additives comprising a shrinkage control composition, a thermal insulation composition, or a combination thereof.

The shrinkage control composition may be included in any of the gypsum core layers as disclosed herein. In general, the shrinkage control composition may be an additive that reduces the gypsum panel's overall shrinkage relative to a control panel that may not include such a composition. For instance, the shrinkage control composition may be included in the first gypsum core layer, the second gypsum core layer, the third gypsum core layer, or a combination thereof.

In one aspect, the shrinkage control composition may be employed in a gypsum core layer adjacent to the first facing material. For instance, when the gypsum core comprises more than one layer, the shrinkage control composition may be employed in the first gypsum core layer. The inclusion of the shrinkage control composition may be particularly beneficial in the first gypsum core layer. For instance, the inclusion of the shrinkage control composition in the first gypsum core layer may delay, mitigate, reduce, or prevent the formation of cracks in the gypsum panel, thermal transmission through the gypsum panel, and/or fall-off of the gypsum panel. Particularly, the first gypsum core layer is generally the first layer of the gypsum core exposed to heat originating from a fire. In this respect, the first gypsum core layer is the first layer of the gypsum panel subject to the formation of cracks and/or fall-off. Thus, the inclusion of the shrinkage control composition in the first gypsum core layer may delay, mitigate, or prevent the formation of cracks and/or fall-off of the gypsum panel. Notably, the formation of cracks and/or fall-off in a gypsum panel is generally disadvantageous as it increases the heat transfer rate through the gypsum panel.

Generally, the shrinkage control composition may include one or more components. For instance, the shrinkage control composition may include a siloxane, a silicone, a silicate, a silica, a ceramic oxide, a metal salt, or a combination thereof. For instance, in some embodiments, such additive may be a siloxane or a silicate. In another embodiment, such additive may be a silica. In a further embodiment, such additive may be a ceramic oxide. In another embodiment, such additive may be a silicone. In a further embodiment, such additive may be a metal salt.

In one embodiment, the shrinkage control composition includes a silicone. The silicone may be a silicone oil, a polysiloxane, etc. In another embodiment, the shrinkage control composition includes a silica.

In a further embodiment, the shrinkage control composition may be a metal salt. For instance, the metal salt may include a halide, such as fluoride or chloride. The metal salt may include a strontium salt, an iron salt, a barium salt, or a mixture thereof. For instance, the metal salt may include a strontium chloride, an iron chloride, barium chloride, or a mixture thereof. In one particular embodiment, the metal salt may include an iron chloride. In another embodiment, the metal salt may include a barium chloride.

In one aspect the shrinkage control composition may include a siloxane. For instance, the shrinkage control composition may include a hydrogen-modified siloxane, such as methyl hydrogen polysiloxane. In one aspect, the siloxane may be combined with other components. For instance, the shrinkage control composition may include a siloxane combined with potassium methyl siliconate.

In another aspect, the shrinkage control composition may include a silica. For instance, the shrinkage control composition may include a colloidal silica, a precipitated silica, a fumed silica, a silica fume, a silicate (e.g., biosilicate, silicate mineral), a crystalline or amorphous silica, a fused silica, a silica gel, or a combination thereof.

In general, the shrinkage control composition, including any components (e.g., a colloidal silica, a precipitated silica, a fumed silica, a silica fume, a silicate, a crystalline or amorphous silica, a fused silica, a silica gel) thereof, may have a silica content of about 20% by weight or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more, such as about 95 wt. % or more, such as about 98 wt. % or more. The shrinkage control composition, including any components thereof, may have a silica content of 100 wt. % or less, such as about 98 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less.

As previously disclosed, in one aspect, the shrinkage control composition may include colloidal silica. The colloidal silica may be a suspension of fine, amorphous, generally spherical silica particles. The silica particles in the colloidal silica may be monodisperse or polydisperse (e.g., bimodal, trimodal) with respect to the particle size distribution of the silica particles. For instance, the deviation in particle size may be about 10% or less, such as about 5% or less, such as about 3% or less, such as about 2% or less, such as about 1% or less. The colloidal silica may have a solids content of about 75 wt. % or less, such as about 60 wt. % or less, such as about 50 wt. % or less, such as about 45 wt. % or less, such as about 35 wt. % or less, such as about 30 wt. % or less. The colloidal silica may have a solids content of about 5 wt. % or more, such as about 10 wt. % or more, such as about 20 wt. % or more, such as about 30 wt. % or more, such as about 40 wt. % or more.

The colloidal silica may have a bulk density of about 1700 kg/m³ to about 2800 kg/m³, such as about 1700 kg/m³ or more, such as about 1800 kg/m³ or more, such as about 1900 kg/m³ or more, such as about 2000 kg/m³ or more, such as about 2100 kg/m³ or more, such as about 2200 kg/m³ or more, such as about 2300 kg/m³ or more, such as about 2400 kg/m³ or more, such as about 2500 kg/m³ or more. Generally, the colloidal silica has a bulk density of less than about 2800 kg/m³, such as about 2500 kg/m³ or less, such as about 2400 kg/m³ or less, such as about 2300 kg/m³ or less, such as about 2200 kg/m³ or less, such as about 2100 kg/m³ or less, such as about 2000 kg/m³ or less, such as about 1900 kg/m³ or less, such as about 1800 kg/m³ or less.

The colloidal silica may have a specific surface area of about 20 m²/g to about 1200 m²/g, such as about 20 m²/g or more, such as about 100 m²/g or more, such as about 200 m²/g or more, such as about 300 m²/g or more, such as about 500 m²/g or more, such as about 800 m²/g or more, such as about 1000 m²/g or more. Generally, the colloidal silica has a specific surface area of about 1200 m²/g or less, such as about 1000 m²/g or less, such as about 800 m²/g or less, such as about 500 m²/g or less, such as about 300 m²/g or less, such as about 200 m²/g or less, such as about 100 m²/g or less.

The colloidal silica may be dispersed in water to form an aqueous dispersion. In this respect, an aqueous dispersion including colloidal silica and water may have a pH of 2 to 12, such as a pH of 2 or more, such as a pH of 4 or more, such as a pH of 6 or more, such as a pH of 8 or more, such as a pH of 10 or more. Generally, the aqueous dispersion including colloidal silica and water has a pH of 12 or less, such as a pH of 10 or less, such as a pH of 8 or less, such as a pH of 6 or less, such as a pH of 4 or less.

In another aspect, the shrinkage control composition may include precipitated silica. As generally known in the art, precipitated silica is produced by precipitation from a solution containing silicate salts. Generally, precipitated silica may be porous and may be present as an agglomerate, which may be referred to as an aggregate. The precipitated silica may have a D50 of about 500 nanometers or more, such as about 1 micron or more, such as about 2 microns or more, such as about 3 microns or more, such as about 5 microns or more, such as about 10 microns or more, such as about 15 microns or more, such as about 25 microns or more, such as about 50 microns or more, such as about 75 microns or more. Generally, the precipitated silica has a D50 of about 100 microns or less, such as about 75 microns or less, such as about 50 microns or less, such as about 40 microns or less, such as about 25 microns or less, such as about 20 microns or less, such as about 15 microns or less, such as about 10 microns or less, such as about 5 microns or less, such as about 4 microns or less, such as about 1 micron or less. Such aforementioned D50, in one embodiment, may refer to the agglomerate size of the precipitated silica.

In a further aspect, the shrinkage control composition may include fumed silica. The fumed silica may include non-porous particles. The fumed silica primary particles may form into tertiary particles, which may be referred to as fumed silica aggregates or fumed silica agglomerates. The fumed silica aggregates may have an average particle size from about 0.05 microns to about 1 micron, such as about 0.05 microns or more, such as about 0.1 microns or more, such as about 0.2 microns or more, such as about 0.3 microns or more, such as about 0.4 microns or more, such as about 0.5 microns or more. Generally, the fumed silica aggregates have an average particle size of about 1 micron or less, such as about 0.8 microns or less, such as about 0.5 microns or less, such as about 0.4 microns or less, such as about 0.3 microns or less, such as about 0.2 microns or less, such as about 0.1 microns or less. Furthermore, in one aspect, the aforementioned values may refer to a median particle size of the fumed silica aggregates.

In yet another aspect, the shrinkage control composition may include silica fume. The silica fume may have a bulk density from about 50 kg/m³ to about 900 kg/m³, such as about 50 kg/m³ or more, such as about 100 kg/m³ or more, such as about 200 kg/m³ or more, such as about 300 kg/m³ or more, such as about 400 kg/m³ or more, such as about 500 kg/m³ or more, such as about 600 kg/m³ or more, such as about 700 kg/m³ or more, such as about 800 kg/m³ or more. Generally, the silica fume has a bulk density of less than about 900 kg/m³, such as about 800 kg/m³ or less, such as about 700 kg/m³ or less, such as about 600 kg/m³ or less, such as about 500 kg/m³ or less, such as about 400 kg/m³ or less, such as about 300 kg/m³ or less, such as about 200 kg/m³ or less, such as about 100 kg/m³ or less.

The silica fume primary particles may have an average particle size from about 0.01 microns to about 120 microns, such as about 0.01 microns or more, such as about 0.5 microns or more, such as about 1 micron or more, such as about 5 microns or more, such as about 10 microns or more, such as about 20 microns or more, such as about 30 microns or more, such as about 50 microns or more. Generally, the average particle size of the silica primary particles is less than about 120 microns, such as about 100 microns or less, such as about 50 microns or less, such as about 30 microns or less, such as about 20 microns or less, such as about 10 microns or less, such as about 5 microns or less, such as about 1 micron or less, such as about 0.5 microns or less. Furthermore, in one aspect, the aforementioned values may refer to a median particle size of the silica primary particles. Additionally, the aforementioned values may refer to the average size of aggregates or agglomerates of silica fume.

In yet another further aspect, the shrinkage control composition may include a silicate (e.g., silicate mineral). The silicate may be in the form of coarse granulated particles and/or fine granulated particles. In one aspect, the silicate mineral may be in the form of a powder. When the silicate is a silicate mineral, the silicate mineral may be any one of a nesosilicate (e.g., calcium silicate), a sorosilicate, a cyclosilicate, an inosilicate (single chain), an inosilicate (double chain), a phyllosilicate (e.g., attapulgite clay, vermiculite), or a tectosilicate. In some aspects, the silicate may be kaolin clay, an alumino-silicate, etc. or a mixture thereof. The shrinkage control composition may include kaolin clay, fillite, expanded fly ash, perlite (perlite ore), pumice (e.g., ground pumice) volcanic ash (tuff), diatomite, phlogopite mica, wollastonite, pyrophyllite, sodium silicate, calcium silicate, or a mixture thereof.

In some aspects, the silicate may be a biosilicate. For instance, the silica may be diatomaceous earth. The diatomaceous earth may be granulated diatomaceous earth, milled diatomaceous earth, micronized diatomaceous earth, calcined diatomaceous earth, or a combination thereof.

In addition to the above, the shrinkage control composition may be a shrinkage control composition that does not burn at a temperature of 400° C. or more, such as about 500° C. or more, such as about 700° C. or more, such as about 900° C. or more.

The shrinkage of a gypsum panel can be measured via thermal mechanical analyzer (TMA). The test is conducted using the ASTM E119-16a ramp rates with a sample size of 5 mm by 5 mm by 11 mm (11 mm thickness). Using TMA, a change in dimension, in particular thickness can be determined and as measured herein, the shrinkage and thickness is based on the values at 950° C. Without the shrinkage control composition as disclosed herein, a gypsum panel (i.e., one containing gypsum, the shrinkage control composition, and other additives) may have an average shrinkage of greater than 20%. However, by employing a shrinkage control composition as disclosed herein, the gypsum panel may exhibit a shrinkage of 20% or less, such as 16% or less, such as 15% or less, such as 14% or less, such as 12% or less, such as 10% or less, such as 8% or less, such as 6% or less, such as 5% or less. The gypsum panel may have an average shrinkage of greater than 0%, such as 0.5% or more, such as 1% or more, such as 2% or more, such as 3% or more, such as 5% or more, such as 10% or more. Such percentages are based on the initial thickness.

As another means for determining the effect of the shrinkage control composition on gypsum, the shrinkage can be measured by determining an area shrinkage (i.e., of a face instead of a thickness). For such area shrinkage, it can be determined utilizing a board sample or a cast gypsum bar (i.e., one containing only gypsum and the shrinkage control composition) such as one having dimensions of 1″×1″×11.25″ (face or back of 1″×11.25″ and a thickness of 1″), drying the bar at 45° C. until a constant mass is obtained, and conditioning the bar at 70° F. and 50% RH for 12 hours. After conditioning, the bars or board samples are placed into a muffle furnace and quickly ramped according to ramp rates as defined in ASTM E119-16a to a temperature of about 950° C. The percentage change in shrinkage is determined by comparing the area after heating with the initial 1″×11.25″ or board sample area.

In general, the shrinkage area of the gypsum panel as determined by the muffle furnace test may be about 20% or less, such as about 15% or less, such as about 12% or less, such as about 10% or less, such as about 9% or less, such as about 8% or less, such as about 7% or less, such as about 6% or less, such as about 5% or less, such as about 4% or less, such as about 3% or less, such as about 2% or less, such as about 1% or less, such as about 0.5% or less. In general, the shrinkage area of the gypsum panel as determined by the muffle furnace test may be greater than 0%, such as about 0.1% or more, such as about 0.2% or more, such as about 0.5% or more, such as about 1% or more, such as about 2% or more, such as about 3% or more, such as about 5% or more.

In order to provide the desired effect, one or more components of the shrinkage control composition may have a particular size. It should be noted that the respective average particle sizes of the components, including the average sizes of particle aggregates or agglomerates (e.g., precipitated silica aggregates, fumed silica aggregates, silica fume aggregates, etc.), previously disclosed herein are non-limiting. For instance, one or more components of the shrinkage control composition may have an average particle size of 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The one or more components of the shrinkage control composition may have an average particle size of 1 nanometer or more, such as 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 50 microns or more, such as 100 microns or more, such as 200 microns or more, such as 300 microns or more, such as 400 microns or more. Furthermore, in one aspect, the aforementioned values may refer to a median particle size of the components of the shrinkage control composition. Additionally, the aforementioned values may refer to the size of the aggregates or agglomerates of the components of the shrinkage control composition.

It should be understood that any of the components of the shrinkage control composition as disclosed herein may be used alone or in any combination. For instance, such combinations may be effective at providing a synergistic effect to reduce the shrinkage of the gypsum panel.

In addition, it should be understood that the point of the process in which the shrinkage control composition is incorporated is not necessarily limited. That is, the shrinkage control composition may be incorporated into a gypsum slurry during, before, and/or after various steps in the manufacturing process. In addition, where multiple shrinkage control compositions are employed, such shrinkage control compositions may be added to the gypsum slurry at the same or at different steps of the manufacturing process. Notably, in one embodiment, the shrinkage control compositions may be added to the gypsum slurry by mixing with the dry ingredients (e.g., stucco). For instance, such shrinkage control compositions may be provided in a mixer of the manufacturing process. Alternatively, the shrinkage control composition may be added in a mill.

As previously disclosed, the gypsum core of the present disclosure may contain a thermal insulation composition. In general, The thermal insulation composition may be included in any of the gypsum core layers as disclosed herein. For instance, the thermal insulation composition may be included in the first gypsum core layer, the second gypsum core layer, the third gypsum core layer, or a combination thereof.

In one aspect, the thermal insulation composition may be employed in the gypsum core layer adjacent to the second facing material. For instance, when the gypsum core comprises a first gypsum core layer, a second gypsum core layer, and a third gypsum core layer, the thermal insulation composition may be employed in the third gypsum core layer, which, in some aspects, is adjacent to the second facing material. The inclusion of the thermal insulation composition may be particularly beneficial in the gypsum core layer adjacent to the second facing material. The gypsum core layer adjacent to the second facing material may be the last layer of the gypsum core exposed to heat originating from a fire. In this respect, the inclusion of the thermal insulation composition in the gypsum core layer adjacent to the second facing material may decrease the rate of heat transfer through the gypsum panel. Particularly, the inclusion of the thermal insulation composition in the gypsum core layer adjacent to the second facing material may delay or prevent the ignition of the building components behind the gypsum panel.

The thermal insulation composition may include one or more components. For instance, the thermal insulation composition may include a metal hydroxide, a volcanic rock, an amorphous volcanic glass, a synthetic porous material, an expanded clay, a mineral hydrate, a polyphosphate, or a combination thereof.

In one aspect, the thermal insulation composition may include a metal hydroxide or a combination of metal hydroxides. The metal may be an alkaline earth metal or a transition metal. In one aspect, the metal may be an alkaline earth metal. In another aspect, the metal may be a transition metal. For instance, the metal may be, but is not limited to, magnesium, strontium, barium, iron, copper, nickel, titanium, zirconium, manganese, cobalt, silver, aluminum, etc. In one aspect, the metal hydroxide may be aluminum hydroxide, which may be referred to as aluminum trihydrate (ATH). In another aspect, the metal hydroxide may be magnesium hydroxide, which may be referred to as magnesium dihydroxide (MDH).

In one aspect, the thermal insulation composition may include volcanic rock. For instance, the volcanic rock may include pumice and/or scoria. In one aspect the pumice may be a mine-grade pumice. In another aspect, the pumice may be a micronized pumice.

The pumice may have an average particle size of about 10 microns to about 2500 microns, such as about 10 microns or more, such as about 25 microns or more, such as about 50 microns or more, such as about 75 microns or more, such as about 100 microns or more, such as about 125 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more. Generally, the average particle size of the pumice may be about 2500 microns or less, such as about 1500 microns or less, such as about 1300 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 150 microns or less, such as about 125 microns or less, such as about 100 microns or less, such as about 75 microns or less, such as about 50 microns or less, such as about 25 microns or less. Furthermore, in one aspect, the aforementioned values may refer to a median particle size of the pumice.

The pumice may have a bulk density from about 100 kg/m³ to about 1300 kg/m³, such as about 100 kg/m³ or more, such as about 200 kg/m³ or more, such as about 300 kg/m³ or more, such as about 400 kg/m³ or more, such as about 500 kg/m³ or more, such as about 600 kg/m³ or more, such as about 700 kg/m³ or more, such as about 750 kg/m³ or more, such as about 800 kg/m³ or more, such as about 850 kg/m³ or more, such as about 900 kg/m³ or more, such as about 1000 kg/m³ or more, such as about 1100 kg/m³ or more. Generally, the pumice has a bulk density of less than about 1300 kg/m³, such as about 1200 kg/m³ or less, such as about 1100 kg/m³ or less, such as about 1000 kg/m³ or less, such as about 900 kg/m³ or less, such as about 850 kg/m³ or less, such as about 800 kg/m³ or less, such as about 750 kg/m³ or less, such as about 700 kg/m³ or less, such as about 600 kg/m³ or less, such as about 500 kg/m³ or less, such as about 400 kg/m³ or less, such as about 300 kg/m³ or less, such as about 200 kg/m³ or less.

In another aspect, the thermal insulation composition may include an amorphous volcanic glass. In one aspect, the amorphous volcanic glass may include perlite. The perlite may be unexpanded perlite, expanded perlite, or a combination thereof. The unexpanded perlite may have a bulk density from about 900 kg/m³ to about 1300 kg/m³, such as about 900 kg/m³ or more, such as about 950 kg/m³ or more, such as about 1000 kg/m³ or more, such as about 1050 kg/m³ or more, such as about 1060 kg/m³ or more, such as about 1070 kg/m³ or more, such as about 1080 kg/m³ or more, such as about 1090 kg/m³ or more, such as about 1100 kg/m³ or more, such as about 1120 kg/m³ or more. Generally, the unexpanded perlite has a bulk density of about 1300 kg/m³ or less, such as about 1200 kg/m³ or less, such as about 1180 kg/m³ or less, such as about 1160 kg/m³ or less, such as about 1140 kg/m³ or less, such as about 1120 kg/m³ or less, such as about 1100 kg/m³ or less, such as about 1080 kg/m³ or less, such as about 1060 kg/m³ or less, such as about 1040 kg/m³ or less, such as about 1020 kg/m³ or less.

In a further aspect, the thermal insulation composition may include a synthetic porous material, such as a thermally resistant additive. For instance, the thermal insulation composition may include an aerogel, such as a silica aerogel. The aerogel may have a density from about 1 kg/m³ to about 500 kg/m³, such as about 1 kg/m³ or more, such as about 10 kg/m³ or more, such as about 25 kg/m³ or more, such as about 50 kg/m³ or more, such as about 75 kg/m³ or more, such as about 100 kg/m³ or more, such as about 150 kg/m³ or more, such as about 200 kg/m³ or more, such as about 300 kg/m³ or more, such as about 400 kg/m³ or more. Generally, the aerogel has a density less than about 500 kg/m³, such as about 400 kg/m³ or less, such as about 300 kg/m³ or less, such as about 200 kg/m³ or less, such as about 150 kg/m³ or less, such as about 100 kg/m³ or less, such as about 75 kg/m³ or less, such as about 50 kg/m³ or less, such as about 25 kg/m³ or less, such as about 10 kg/m³ or less.

In yet another further aspect, the thermal insulation composition may include one or more expanded clays. The expanded clay may have a bulk density from about 50 kg/m³ to about 1200 kg/m³, such as about 50 kg/m³ or more, such as about 100 kg/m³ or more, such as about 150 kg/m³ or more, such as about 200 kg/m³ or more, such as about 250 kg/m³ or more, such as about 300 kg/m³ or more, such as about 400 kg/m³ or more, such as about 500 kg/m³ or more, such as about 600 kg/m³ or more, such as about 700 kg/m³ or more, such as about 800 kg/m³ or more, such as about 900 kg/m³ or more. Generally, the expanded clay has a bulk density of less than about 1200 kg/m³, such as about 900 kg/m³ or less, such as about 800 kg/m³ or less, such as about 700 kg/m³ or less, such as about 600 kg/m³ or less, such as about 500 kg/m³ or less, such as about 400 kg/m³ or less, such as about 350 kg/m³ or less, such as about 300 kg/m³ or less, such as about 250 kg/m³ or less, such as about 200 kg/m³ or less, such as about 150 kg/m³ or less, such as about 100 kg/m³ or less.

In general, the thermal insulation composition may have a specific mechanism or means of absorbing heat. For instance, it may be referred to as and/or comprise an endothermic additive, a thermally resistant additive, a flame-retardant additive, an intumescent additive, a charring additive, or a combination thereof. In this regard, each mechanism may be distinguishable from another. However, regardless of the mechanism, such additive may be able to reduce the flow of heat from a front facing material of a gypsum panel to a back facing material of a gypsum panel. For instance, it may be able to slow heat conduction and/or convection through the gypsum panel. Furthermore, it should be understood that the aforementioned additives may be utilized individually or in any combination.

In general, the thermal insulation composition may have a specific mechanism or means of absorbing heat. For instance, it may be referred to as and/or comprise an endothermic additive, a thermally resistant additive, a flame-retardant additive, an intumescent additive, or a charring additive. In this regard, each mechanism may be distinguishable from another. For instance, without intending to be limited by theory, the mechanism may be as follows: (a) endothermic material—absorbs heat and delays thermal transmission before undergoing a chemical transformation (e.g., calcium sulfate dehydrate losing water upon exposure to heat) often requiring more energy to undergo chemical change than its matrix; (b) thermally resistant material—undergoes chemical (or physical) change at temperatures higher than its corresponding matrix (e.g., the gypsum core) and potentially provides reinforcement/shrinkage resistance upon exposure to heat and fire as a result and may also be a material that shows low heat transfer; (c) flame retardant material—resists the chemical reaction associated with burning to improve flame retardancy (e.g., to improve the gypsum flame retardant and smoke developed classes of gypsum materials) wherein the suppression can occur via various mechanisms from gas/vapor release to char formation; (d) intumescent additive—expands along one or more axes to increase in volume upon exposure to heat wherein the expansion causes the matrix itself to expand which in turn increases the thermal resistance (heat/thermal delay) of the matrix itself; and (e) charring additives—undergo a chemical degradation reaction to create an insulation layer to protect against heat and fire. It should be understood that the aforementioned provides general descriptions and thus should not be limiting.

However, regardless of the mechanism, such thermal insulation composition may be able to reduce the flow of heat from a front face of a gypsum panel to a back face of a gypsum panel. For instance, it may be able to slow heat conduction and/or convection through the gypsum panel. Furthermore, it should be understood that the aforementioned additives may be utilized individually or in any combination.

In one aspect, the thermal insulation composition may include an endothermic material. For instance, endothermic materials may generally absorb energy or heat from their surroundings. In this regard in certain embodiments, such materials may be capable of absorbing energy without undergoing a phase change. These may include a hydrate, a hydroxide, a borate, a phosphate, a carbonate, a nitrate, a clay, as well as a mixture thereof.

For instance, the thermal insulation composition may include a hydrate such as mineral hydrates. The hydrates may include chlorite, muscovite, brucite, goethite, hydromagnesite, talc, saponite, amphibole, lawsonite, zoisite, chloritoid, borax, sodium tetra borate decahydrate, sodium carbonate decahydrate, sodium sulfate decahydrate, zeolites, sodium phosphate tribasic dodecahydrate, ettringite magnesium phosphate pentahydrate, magnesium sulfate heptahydrate, magnesium carbonate basic pentahydrate, aluminum oxide hydrate, aluminum trihydrate, boehmite, magnesium hydrate, calcium hydrate, or a mixture thereof. In certain embodiments, the hydrate may be a vapor emissive material.

The thermal insulation composition may include a hydroxide, such as metal hydroxides. The hydroxides may include magnesium hydroxide, calcium hydroxide, aluminum hydroxide, or a mixture thereof.

The thermal insulation composition may include a borate. For instance, the borate may include sodium borate, zinc borate, boric acid, tincalconite, colemanite, ulexite, or a mixture thereof.

The thermal insulation composition may include a phosphate. For instance, the phosphonate may include magnesium phosphate, hydroxyapatite, or a mixture thereof. The thermal insulation composition may include a carbonate. For instance, the carbonate may include magnesium carbonate, calcium carbonate, or a mixture thereof. The thermal insulation composition may include a nitrate. For instance, the nitrate may include sodium nitrate. The thermal insulation composition may include a clay. For instance, the clay may be smectite.

In one embodiment, the thermal insulation composition may be a thermally resistant additive. The thermally resistant additive may include volcanic ash, an aerogel, soda-lime glass, a borosilicate glass, or a mixture thereof. For instance, the volcanic ash may be tuff. Furthermore, these materials may also include aerogels. The soda-lime glass may include glass beads, glass bubbles, glass spheres, or a mixture thereof. The glass may also be various types of glass such as glass derived from bottles or recycled and is thus not necessarily limited.

In another embodiment, the thermal insulation composition may be a charring additive. For instance, the charring additive may be a polyphosphate. For instance, the polyphosphate may be ammonium polyphosphate, melamine polyphosphate, or a mixture thereof.

In a further embodiment, the thermal insulation composition may be a flame-retardant type additive. Such additives may include red phosphorus, a phosphate, a phosphoric acid, a phosphonic acid, or a mixture thereof. For instance, the phosphate may include a melamine phosphate, ammonium polyphosphate, tris(1,3-dichloro-2propane) phosphate, 2-propanol, 1,3-dichloro-phosphate, phosphoric acid tris(2-chloro-1-methylethyl) ester, resorcinol bis(diphenylphosphate), tris(isopropylated-phenyl) phosphate, or a mixture thereof. The phosphonic acid may include phosphonic acid, methyl-bis(5-ethyl-2-methyl-1,3,2-diozaphosphosphorian-5-yl)methyl)ester.

In another embodiment, the thermal insulation composition may be an intumescent material. For instance, the intumescent material may include graphite, vermiculite, or a mixture thereof. The graphite may be unexpanded or expanded. The vermiculite may be unexpanded or expanded. In addition, the vermiculite may be any grade or combination of grades as known in the art.

In another further embodiment, the thermal insulation composition may be a synergist type material, in particular for improving fire resistance. Such materials may include antimony. For instance, the additive may include antimony trioxide, antimony pentoxide, or a mixture thereof.

In order to provide the desired effect, the one or more components of the thermal insulation composition may have a particular size. It should be noted that the respective average particle sizes of the components of the thermal insulation composition previously disclosed herein (e.g., pumice) are non-limiting. For instance, the components of the thermal insulation composition may have an average particle size of 3000 microns or less, such as 2500 microns or less, such as 2200 microns or less, such as 2000 microns or less, such as 1800 microns or less, such as 1500 microns or less, such as 1200 microns or less, such as 1000 microns or less, such as 800 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The components of the thermal insulation composition may have an average particle size of 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 50 microns or more, such as 100 microns or more, such as 200 microns or more, such as 300 microns or more, such as 400 microns or more, such as 500 microns or more, such as 800 microns or more, such as 1000 microns or more, such as 1200 microns or more, such as 1500 microns or more, such as 1800 microns or more, such as 2000 microns or more, such as 2200 microns or more, such as 2500 microns or more. Furthermore, in one aspect, the aforementioned values may refer to a median particle size of the components of the thermal insulation composition.

It should be understood that any of the components of the thermal insulation composition as disclosed herein may be used alone or in any combination. For instance, such combinations may be effective at providing a synergistic effect to enhance thermal insulation.

In addition, it should be understood that the point of the process in which the thermal insulation composition is incorporated is not necessarily limited. That is, the thermal insulation composition may be incorporated into a gypsum slurry during, before, and/or after various steps in the manufacturing process. In addition, where multiple thermal insulation compositions are employed, such thermal insulation compositions may be added to the gypsum slurry at the same or at different steps of the manufacturing process. Notably, in one embodiment, the thermal insulation compositions may be added to the gypsum slurry by mixing with the dry ingredients (e.g., stucco). For instance, such thermal insulation compositions may be provided in a mixer of the manufacturing process. Alternatively, the thermal insulation composition may be added in a mill. In some embodiments, the thermal insulation compositions may be added in a liquid. For instance, a thermal insulation composition may be incorporated into a solution or a suspension before such solution or suspension is added into the process disclosed herein.

The one or more fire resistance additives (e.g., shrinkage control composition, thermal insulation composition) may be present in the gypsum panel in an amount of 0.001 lbs/MSF to 500 lbs/MSF, including all increments of 0.001 lbs/MSF therebetween. For instance, the one or more fire resistance additives may be present in the gypsum panel in an amount of 0.001 lbs/MSF or more, such as 0.01 lbs/MSF or more, such as 0.05 lbs/MSF or more, such as 0.1 lb/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 50 lbs/MSF or more, such as 100 lbs/MSF or more, such as 125 lbs/MSF or more, such as 200 lbs/MSF or more, such as 300 lbs/MSF or more, such as 400 lbs/MSF or more. Generally, the one or more fire resistance additives may be present in the gypsum panel in an amount of 500 lbs/MSF or less, such as 400 lbs/MSF or less, such as 300 lbs/MSF or less, such as 200 lbs/MSF or less, such as 150 lbs/MSF or less, such as 125 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

Further, the one or more fire resistance additives (e.g., shrinkage control composition, thermal insulation composition) may be present in a gypsum panel, including any component thereof, in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more, such as 5 wt. % or more, such as 8 wt. % or more, such as 10 wt. % or more, such as 12 wt. % or more, such as 15 wt. % or more, such as 18 wt. % or more, such as 20 wt. % or more, such as 22 wt. % or more, such as 25 wt. % or more. Generally, the one or more fire resistance additives may be present in a gypsum panel, including any component thereof, in an amount of 40 wt. % or less, such as 35 wt. % or less, such as 30 wt. % or less, such as 25 wt. % or less, such as 20 wt. % or less, such as 15 wt. % or less, such as 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.30 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The silica content of one or more of the respective gypsum core layers may be from 0.01 wt. % to 15 wt. % by weight of the one or more of the gypsum core layers, including all increments of 0.01 wt. % therebetween, such as 0.01 wt. % or more, such as 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more, such as 11 wt. % or more, such as 15 wt. % or less, such as 11 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less, such as 1 wt. % or less.

In one aspect, when the gypsum core of the present disclosure has three layers, the shrinkage control composition is employed in the first gypsum core layer and the thermal insulation composition is employed in the third gypsum core layer. In this respect, the second gypsum core layer may be free of fire resistance additives. The inclusion of the shrinkage control composition in the first gypsum core layer and the inclusion of the thermal insulation composition in the third gypsum core layer may be particularly beneficial. For instance, all of the benefits previously discussed herein regarding the inclusion of the shrinkage control composition in the first gypsum core layer and the inclusion of thermal insulation composition in the third gypsum core layer are applicable. Further, such a configuration may provide for a synergistic effect that enhances the fire resistance properties of a gypsum panel. In one aspect, the first gypsum core layer and/or third gypsum core layer may have a density greater than the second gypsum core layer.

The inclusion of the shrinkage control composition and/or the thermal insulation composition in the first gypsum core layer and/or third gypsum core layer may be particularly advantageous in providing a lightweight gypsum panel. For instance, in one aspect, when the shrinkage control composition and/or the thermal insulation composition are present in the first gypsum core layer and/or third gypsum core layer, the exclusion of the shrinkage control composition and/or the thermal insulation composition from the second gypsum core layer may result in a lightweight fire resistant gypsum panel.

Notably, a shrinkage control composition can be utilized to interfere with the sintering of gypsum crystals. Without intending to be limited by theory, such sintering would result in shrinkage of the panel thereby affecting the overall dimensions of the panel. For instance, a shrinkage control composition may be present at a gypsum/gypsum interface to interrupt fusion of the gypsum crystals into one mass or agglomeration. Furthermore, the thermal insulation composition may be utilized to reduce the flow of heat from a front face of a gypsum panel to a back face of a gypsum panel. In this regard, the temperature along the back of a panel, when installed, may be less than a similar gypsum panel without such an additive.

Notably, a shrinkage control composition and a thermal insulation composition may be present in the gypsum panel in a weight ratio from about 1:20 to about 20:1, including all incremental ratios therebetween. For instance, the shrinkage control composition and the thermal insulation composition may be present in the gypsum panel in a weight ratio of about 1:20 or more, such as about 1:10 or more, such as about 1:5 or more, such as about 1:4 or more, such as about 1:2 or more, such as about 1:1 or more, such as about 2:1 or more, such as about 4:1 or more, such as about 5:1 or more, such as about 10:1 or more, such as about 20:1 or less, such as about 10:1 or less, such as about 5:1 or less, such as about 4:1 or less, such as about 2:1 or less, such as about 1:1 or less, such as about 1:2 or less, such as about 1:4 or less, such as about 1:5 or less, such as about 1:10 or less.

In one aspect, the gypsum panel of the present disclosure may be manufactured so as to pass the necessary UL tests for fire resistance. For instance, the gypsum panel may pass ASTM E119-16a, which is the standard test method for a fire test of a building construction and materials.

Notably, in some aspects, an assembly may be constructed using gypsum panels of the present disclosure wherein the assembly may conform to the specification of Underwriters Laboratories, Inc. (UL®) assemblies, such as U419, U305, and U423. For a fire test, the face of one side of the assembly can be exposed to increasing temperatures for a period of time in accordance with a heating curve, such as those discussed in ASTM E119-16a. The temperatures proximate the heated side and the temperatures at the surface of the unheated side of the assembly are monitored during the tests to evaluate the temperatures experienced by the exposed gypsum panels and the heat transmitted through the assembly to the unexposed panels.

In this regard, in one aspect, an assembly of gypsum panels formed according to the present disclosure and in accordance with the specification of a U419 assembly, with or without cavity insulation, may have a fire rating of at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less.

In one aspect, an assembly of gypsum panels formed according to the present disclosure and in accordance with the specification of a U305 assembly may have a fire rating of at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less.

In one aspect, an assembly of gypsum panels formed according to the present disclosure and in accordance with the specification of a U423 assembly may have a fire rating of at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be 75 minutes or less, such as 73 minutes or less, such as 71 minutes or less, such as 70 minutes or less, such as 69 minutes or less, such as 68 minutes or less, such as 67 minutes or less, such as 66 minutes or less, such as 65 minutes or less, such as 64 minutes or less, such as 63 minutes or less, such as 62 minutes or less, such as 61 minutes or less.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants, fillers (e.g., glass spheres, glass fibers), natural and synthetic fibers (e.g. cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches, sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As indicated herein, the gypsum core is sandwiched by facing materials (e.g., first facing material, second facial material). The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes one or more fire resistance additives. In this regard, the method may include a step of also combining one or more fire resistance additives with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may also include water. Water may be employed for fluidity and also for rehydration of the gypsum to allow for setting. The amount of water utilized is not necessarily limited by the present invention.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses and other fibers (e.g. cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, a foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 90 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more. The gypsum slurry may have bubbles or voids having a median size of 1400 microns or less, such as 1300 microns or less, such as 1200 microns or less, such as 1100 microns or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate.

In another embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

The manner in which the components for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for dewatering of the gypsum slurry, in particular dewatering any free water instead of combined water of the gypsum slurry. Such dewatering may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for removal of any free water. The temperature and time required for drying in such heating device are not necessarily limited by the present invention.

As previously disclosed, the gypsum core may have one or more gypsum core layers.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less than the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

As indicated herein, the gypsum core can include one or more fire resistance additives. In this regard, in one embodiment, the first gypsum core layer may include one or more of the fire resistance additives disclosed herein. In another embodiment, the second gypsum core layer may include one or more of the fire resistance additives as disclosed herein. In a further embodiment, the third gypsum core layer may include one or more of the fire resistance additives as disclosed herein. In an even further embodiment, the first gypsum core layer and the second gypsum core layer may include one or more of the fire resistance additives as disclosed herein. In another further embodiment, the first gypsum core layer, the second gypsum core layer, and the third gypsum core layer may include one or more of the fire resistance additives as disclosed herein.

In one aspect, the shrinkage control composition may be present in only one layer of the gypsum core. In another aspect, the thermal insulation composition may be present in only one layer of the gypsum core.

Regardless of the above, one or more fire resistance additives may be present in any combination of gypsum core layers. However, in one embodiment, it should be understood that one or two of the aforementioned gypsum core layers may not include a fire resistance additive. In one aspect, one or more gypsum core layers may comprise the same fire resistance additives. Further, in one aspect, the one or more gypsum core layers may comprise different fire resistance additives. The different fire resistance additives of the one or more gypsum core layers may be chosen such that it is advantageous to have a particular fire resistance additive in one gypsum core layer and a different fire resistance additive in another, different gypsum core layer.

The gypsum panel disclosed herein may have many applications. For instance, the gypsum panel may be used as a standalone panel in construction for the preparation of walls, ceilings, roofs, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

The specific surface area of the gypsum core is not necessarily limited and may be, in one aspect, from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about, 300 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The thickness of the gypsum panel, and in particular, the gypsum core, or any respective layer of the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, a gypsum panel formed in accordance with the present disclosure may be a lightweight gypsum panel. In one aspect, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2200 lbs/MSF or less, such as about 2100 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396 and ASTM C473. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396 and ASTM C473. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

Gypsum panels were made in accordance with the descriptions below. The gypsum panels were analyzed to determine the fire resistance of the respective gypsum panels. For testing, a 12′×12′ sample was mounted onto a muffle furnace wall and subjected to a modified ASTM E119-16a heat ramp rate. In this respect, the samples are placed into a muffle furnace and ramped using the following modified ASTM E119-16a heat ramp rate: at 5 mins=165° C.; at 10 mins=330° C.; at 30 mins=843° C.; at 60 mins=927° C. All of the Examples (i.e., Example 1-5) underwent this testing. Notably, each sample was conditioned before being placed in the muffle furnace.

### Example 1

Gypsum panels were made which did and did not include fire resistance additives in the respective gypsum panels. As observed in Tables 1 and 2, various additives were tested for their ability to enhance the fire resistance properties of a gypsum panel. In Table 1, for all samples except for the “Control”, the respective fire resistance additive was added to the gypsum panel in an amount of 2 wt. % based on the weight of the stucco utilized to form the dense layer of the gypsum core. Further, colloidal silica was added in an amount of 2 wt. % based on the weight of stucco utilized to form the other gypsum core layer for the “Colloidal Silica (Dense Layer and Core)” sample. In Table 2, for all samples except for the “Control”, the respective fire resistance additive was added to the gypsum panel in an amount of 2 wt. % based on the weight of the stucco utilized to form the gypsum core. The “Control” samples of Table 1 and Table 2 did not include a fire resistance additive. The “#⅛ Pumice” indicates a pumice where a mesh size of 75 microns retains 85% to 100% of the pumice by weight, a mesh size of 150 microns retains 70% to 90% of the pumice by weight, a mesh size of 300 microns retains 40% to 75% of the pumice by weight, and a mesh size of 600 microns retains 20% to 60% of the pumice by weight. All of the times indicated in Table 1 and Table 2 are in the form of “minutes:seconds”. The location of the fire resistance additive in the respective gypsum panels of Table 1 and Table 2 is indicated by the parenthesized letters adjacent the fire resistance additive “Sample” name. The dense layer of the respective samples was facing the outside of the furnace cavity. In this respect, the dense layer was closer to the wall of the furnace cavity than the other gypsum core layer. For each of the samples, the temperature at the back of the gypsum panel was determined using a thermocouple. The thermocouple was positioned at the center of the back of the gypsum panel and measured the temperature of the unexposed side of the gypsum panel.

TABLE 1

| | | Time | Peak | Time to | Temperature |
|---|---|---|---|---|---|
| | Board | to | Temper- | Peak | at 60 |
| | Weight | 125° | ature | Temper- | Minutes |
| Sample | [lbs/MSF] | C. | [° C.] | ature | [° C.] |
| Control | 1803 | 25:47 | 478 | 33:10 | 391 |
| Colloidal Silica | 1802 | 26:10 | 483 | 33:30 | 382 |
| (Dense Layer) | | | | | |
| Colloidal Silica | 1765 | 26:30 | 466 | 34:20 | 375 |
| (Dense Layer | | | | | |
| and Core) | | | | | |
| # 1/8 Pumice | 1802 | 26:10 | 495 | 32:40 | 360 |
| (Dense Layer) | | | | | |

TABLE 2

| | | Time | Peak | Time to | Temperature |
|---|---|---|---|---|---|
| | Board | to | Temper- | Peak | at 60 |
| | Weight | 125° | ature | Temper- | Minutes |
| Sample | [lbs/MSF] | C. | [° C.] | ature | [° C.] |
| Control | 1736 | 23:20 | 510 | 30:50 | 391 |
| # 1/8 Pumice | 1782 | 24:50 | 486 | 32:20 | 408 |
| (Core) | | | | | |
| Colloidal | 1765 | 26:20 | 466 | 34:20 | 384 |
| Silica (Core) | | | | | |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising a gypsum core and a first facing material and a second facing material sandwiching the gypsum core, the gypsum core comprising gypsum and one or more fire resistance additives comprising a shrinkage control composition, a thermal insulation composition, or a combination thereof, the gypsum core comprising a first gypsum core layer, a second gypsum core layer, and a third gypsum core layer, wherein the first gypsum core layer comprises the shrinkage control composition, wherein the third gypsum core layer comprises the thermal insulation composition.

2. The gypsum panel of claim 1, wherein the shrinkage control composition comprises a siloxane, a silica, a silicone, a silicate, a ceramic oxide, a metal salt, or a combination thereof.

3. The gypsum panel of claim 2, wherein the shrinkage control composition comprises the siloxane.

4. The gypsum panel of claim 3, wherein the siloxane is methyl hydrogen polysiloxane.

5. The gypsum panel of claim 3, wherein the shrinkage control composition further comprises potassium methyl siliconate.

6. The gypsum panel of claim 2, wherein the shrinkage control composition comprises the silica.

7. The gypsum panel of claim 6, wherein the silica is a colloidal silica, a precipitated silica, a fumed silica, a silica fume, a silicate, or a combination thereof.

8. The gypsum panel of claim 1, wherein the thermal insulation composition includes an endothermic additive, a thermally resistant additive, a flame-retardant additive, an intumescent additive, a charring additive, or a mixture thereof.

9. The gypsum panel of claim 1, wherein the thermal insulation composition comprises a metal hydroxide, a volcanic rock, an amorphous volcanic glass, a synthetic porous material, an expanded clay, a mineral hydrate, a polyphosphate, or a combination thereof.

10. The gypsum panel of claim 1, wherein the thermal insulation composition has a bulk density of about 1300 kg/m³ or less.

11. The gypsum panel of claim 1, wherein the thermal insulation composition has an average particle size of about 2500 microns or less.

12. The gypsum panel of claim 1, wherein only one layer of the gypsum core comprises the shrinkage control composition.

13. The gypsum panel of claim 1, wherein only one layer of the gypsum core comprises the thermal insulation composition.

14. The gypsum panel of claim 1, wherein only one layer of the gypsum core comprises the shrinkage control composition and only one layer of the gypsum core comprises the thermal insulation composition.

15. The gypsum core of claim 1, wherein the second gypsum core layer does not contain the one or more fire resistance additives.

16. The gypsum panel of claim 1, wherein the first gypsum core layer is between the first facing material and the second gypsum core layer.

17. The gypsum panel of claim 1, wherein the first gypsum core layer is adjacent the first facing material.

18. The gypsum panel of claim 1, wherein the third gypsum core layer is between the second facing material and the second gypsum core layer.

19. The gypsum panel of claim 1, wherein the third gypsum core layer is adjacent the second facing material.

20. The gypsum panel of claim 1, wherein the shrinkage control composition is present in the first gypsum core layer in an amount from about 0.01 wt. % to about 30 wt. % based on the weight of gypsum in the first gypsum core layer.

21. The gypsum panel of claim 1, wherein the thermal insulation composition is present in the third gypsum core layer in an amount from about 0.01 wt. % to about 30 wt. % based on the weight of gypsum in the third gypsum core layer.

22. The gypsum panel of claim 1, wherein the first gypsum core layer has a density greater than the second gypsum core layer.

23. The gypsum panel of claim 1, wherein the third gypsum core layer has a density greater than the second gypsum core layer.

24. The gypsum panel of claim 1, wherein the first gypsum core layer and the third gypsum core layer each have a density greater than the second gypsum core layer.

25. The gypsum panel of claim 1, wherein the gypsum panel exhibits an area shrinkage of less than 20%.

26. The gypsum panel of claim 1, wherein the gypsum panel weighs less than about 2500 lbs/MSF.

27. The gypsum panel of claim 1, wherein the gypsum panel passes ASTM E119-16a.

28. A method for making the gypsum panel of claim 1 comprising:
providing the first facing material;
depositing a first gypsum slurry comprising stucco, water, and a shrinkage control composition onto the first facing material, wherein the first gypsum slurry forms the first gypsum core layer;
depositing a second gypsum slurry comprising stucco and water onto the first gypsum slurry, wherein the second gypsum slurry forms the second gypsum core layer;
depositing a third gypsum slurry comprising stucco, water, and a thermal insulation composition onto the second gypsum slurry, wherein the third gypsum slurry forms the third gypsum core layer;
providing the second facing material on the third gypsum slurry; and
allowing the stucco to convert to calcium sulfate dihydrate.
